(19) United States
(12) Patent Application Publication
(10) Pub. No.: US 2017/0280924 A1
(43) Pub. Date: Oct. 5, 2017

(54) BEVERAGE PREPARATION APPARATUS

(71) Applicant: Sharp Kabushiki Kaisha, Sakai City, Osaka (JP)

(72) Inventor: Yasuaki SAKANE, Sakai City, Osaka (JP)

(73) Assignee: Sharp Kabushiki Kaisha, Sakai City, Osaka (JP)

(21) Appl. No.: 15/506,156

(22) PCT Filed: Nov. 25, 2015
(86) PCT No.: PCT/JP2015/083046

§ 371 Date: Feb. 23, 2017

(30) Foreign Application Priority Data
Dec. 16, 2014 (JP) 2014-254241

(51) Int. Cl. A47J 31/44; A47J 31/60; A47J 31/54; A47J 31/00

(52) U.S. Cl. CPC A47J 31/44; A47J 31/002; A47J 31/60; A47J 31/54; A47J 31/10

(57) ABSTRACT

A beverage preparation apparatus includes a liquid storage tank storing a liquid, a heating device for heating the liquid, a tank to which the liquid heated by the heating device is supplied, a liquid supply path having one end connected to the liquid storage tank and the other end serving as a supply port supplying the liquid to the tank, an air passage path including an air inlet and an air outlet and sending air into the tank, and a fan arranged in the air passage path. The air outlet is provided to send air at least to the liquid supplied from the supply port into the tank in supply of the liquid heated by the heating device to the agitation tank.

### TECHNICAL FIELD

The present invention relates to a beverage preparation apparatus capable of cooling a heated liquid supplied to an agitation tank to a prescribed temperature.

### BACKGROUND ART

Various types of beverage preparation apparatuses capable of cooling a produced beverage to a prescribed temperature have conventionally been developed. For example, Japanese Utility Model Laying-Open No. 4-044840 (PTD 1) discloses a beverage preparation apparatus of such a type.

Various types of electric pots capable of cooling boiled water to a prescribed temperature have also been developed, although they are not beverage preparation apparatuses. For example, Japanese Patent Laying-Open No. 6-269354 (PTD 2) discloses an electric pot of such a type.

The beverage preparation apparatus disclosed in PTD 1 cools a beverage at a high temperature extracted into a container to a temperature around a room temperature by cooling the container with a fan provided in a main body.

In the electric pot disclosed in PTD 2, hot water boiled in a container is circulated to any one of a first heat exchanger and a second heat exchanger by using an electric pump. By cooling a heat radiation fin to which the first heat exchanger and the second heat exchanger are attached with the fan, heat of hot water is radiated to the outside through the heat radiation fin and hot water in the container is cooled to a prescribed temperature.

### CITATION LIST

### Patent Document

### PTD 1: Japanese Utility Model Laying-Open No. 4-044840

### PTD 2: Japanese Patent Laying-Open No. 6-269354

### SUMMARY OF INVENTION

### Technical Problem

Since the beverage preparation apparatus described in PTD 1 cools a beverage in the container indirectly by cooling the container, it takes a long time for cooling in an example in which a container low in thermal conductivity is employed, and such a beverage preparation apparatus is unfavorable.

Since the electric pot described in PTD 2 requires a heat exchanger, a pump, and a fan for circulating hot water to the heat exchanger, an apparatus is large-scale and cost for manufacturing also increases. In any case, sensible heat of hot water is removed for lowering a temperature, and a temperature of hot water is not lowered by removing great latent heat of evaporation of hot water.

The present invention was made in view of the problems as above, and an object of the present invention is to provide a beverage preparation apparatus simplified in construction which is capable of adjusting a temperature of a liquid without increase in time period for cooling.

### Solution to Problem

A beverage preparation apparatus based on the present invention includes a liquid storage tank storing a liquid, a heating device for heating the liquid, a tank to which the liquid heated by the heating device is supplied, a liquid supply path having one end connected to the liquid storage tank and the other end serving as a supply port supplying the liquid to the tank, an air passage path including an air inlet and an air outlet for sending air into the tank, and a fan arranged in the air passage path. The air outlet is provided to send air at least to the liquid supplied from the supply port into the tank in supply of the liquid heated by the heating device to the tank.

In the beverage preparation apparatus based on the present invention, preferably, the air outlet is provided in at least a part of a periphery of the supply port.

In the beverage preparation apparatus based on the present invention, preferably, the air passage path includes an air outlet chamber communicating with the air outlet on a side of the air outlet and changing a direction of air sent by the fan toward the tank. In this case, preferably, the air outlet chamber is provided to be able to drain from the air outlet toward the tank, condensation water which adheres to the air outlet chamber due to entry from the air outlet into the air outlet chamber and condensation of vapor from the liquid supplied into the tank.

The beverage preparation apparatus based on the present invention preferably further includes a housing accommodating the liquid supply path and the air passage path. In this case, preferably, the housing has a through hole such that the supply port and the air outlet face the tank. The liquid supply path preferably includes a supply nozzle provided with the supply port and a connection pipe connecting the supply nozzle and the liquid storage tank to each other, and preferably, the supply nozzle has a fitting portion removably fitted to the connection pipe and is pivotably attached to the through hole such that the supply port communicates with the through hole. In this case, preferably, the liquid supply path is provided by pivoting the supply nozzle and fitting the fitting portion into the connection pipe after the supply nozzle is attached to the through hole. The air passage path preferably includes an air duct provided with the air outlet and a connection duct connecting the air duct and the air inlet to each other, and preferably, the air duct has an insertion portion removably inserted in the connection duct and is pivotably attached to the through hole such that the air outlet communicates with the through hole. In this case, the air passage path is preferably provided by pivoting the air duct and inserting the insertion portion into the connection duct after the air duct is attached to the through hole.

In the beverage preparation apparatus based on the present invention, preferably, the supply nozzle and the air duct constitute a double wall structure, and the supply nozzle and the air duct are preferably simultaneously attached to the through hole.

The beverage preparation apparatus based on the present invention preferably further includes a control portion controlling an operation of the heating device and an operation of the fan. In this case, the control portion preferably adjusts a temperature of the liquid supplied to the tank by controlling the operation of the heating device and the operation of the fan.

In the beverage preparation apparatus based on the present invention, preferably, the control portion adjusts the temperature of the liquid supplied to the tank to 70° C. or lower by continuously driving the fan after supply of a prescribed amount of liquid to the tank until end of supply of the liquid to the tank.

### Advantageous Effects of Invention

According to the present invention, a beverage preparation apparatus simplified in construction which is capable of adjusting a temperature of a liquid without increase in time period for cooling is provided.

### BRIEF DESCRIPTION OF DRAWINGS

FIG. 1 is an overall perspective view of a beverage preparation apparatus according to a first embodiment.

FIG. 2 is an overall perspective view showing a component of the beverage preparation apparatus in FIG. 1.

FIG. 3 is a perspective view of a milling unit provided in the beverage preparation apparatus shown in FIG. 1.

FIG. 4 is an exploded perspective view of the milling unit shown in FIG. 3.

FIG. 5 is a vertical cross-sectional view of the milling unit shown in FIG. 3.

FIG. 6 is a cross-sectional view showing a schematic construction of the beverage preparation apparatus shown in FIG. 1.

FIG. 7 is a perspective view of an internal structure of the beverage preparation apparatus shown in FIG. 1 viewed from a side of a tank.

FIG. 8 is a perspective view of the internal structure of the beverage preparation apparatus shown in FIG. 1 viewed from a side of an agitation tank.

FIG. 9 is a perspective view showing a path formation member shown in FIG. 8.

FIG. 10 is a perspective view of the path formation member shown in FIG. 8 viewed from a side of an air outlet and a supply port.

FIG. 11 is an exploded perspective view of the path formation member shown in FIG. 8.

FIG. 12 is a diagram showing the inside of the path formation member shown in FIG. 8.

FIG. 13 is a cross-sectional view along the line XIII-XIII shown in FIG. 9.

FIG. 14 is a cross-sectional view along the line XIV-XIV shown in FIG. 9.

FIG. 15 is a diagram illustrating an operation in attachment of the path formation member shown in FIG. 8.

FIG. 16 is a cross-sectional view showing a state of supply of hot water to the agitation tank in the beverage preparation apparatus shown in FIG. 1.

FIG. 17 is a timing chart in preparation of tea with the beverage preparation apparatus shown in FIG. 1.

FIG. 18 is a timing chart in preparation of tea with a beverage preparation apparatus according to a second embodiment.

FIG. 19 is a timing chart in preparation of tea with a beverage preparation apparatus according to a third embodiment.

FIG. 20 is a timing chart in preparation of tea with a beverage preparation apparatus according to a fourth embodiment.

FIG. 21 is a diagram showing a condition and a result of a first verification experiment conducted for verifying an effect of the present invention.

FIG. 22 is a diagram showing a condition and a result of a second verification experiment conducted for verifying an effect of the present invention.

### DESCRIPTION OF EMBODIMENTS

Embodiments of the present invention will be described below in detail with reference to the drawings. In the embodiments shown below, the same or common elements have the same reference numerals allotted in the drawings and description thereof will not be repeated.

### First Embodiment

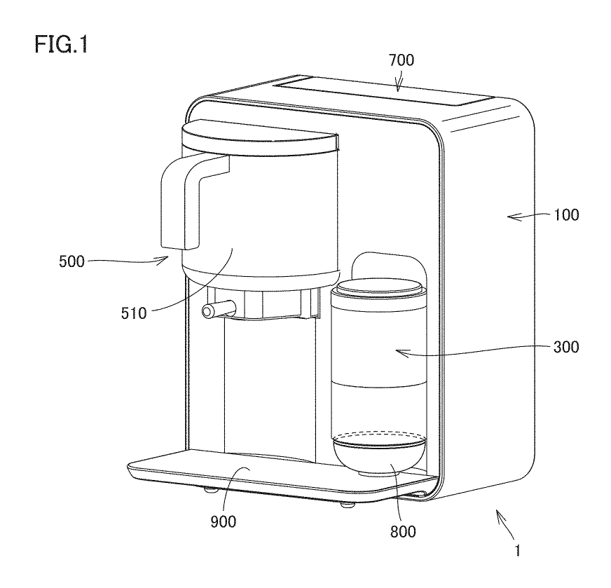

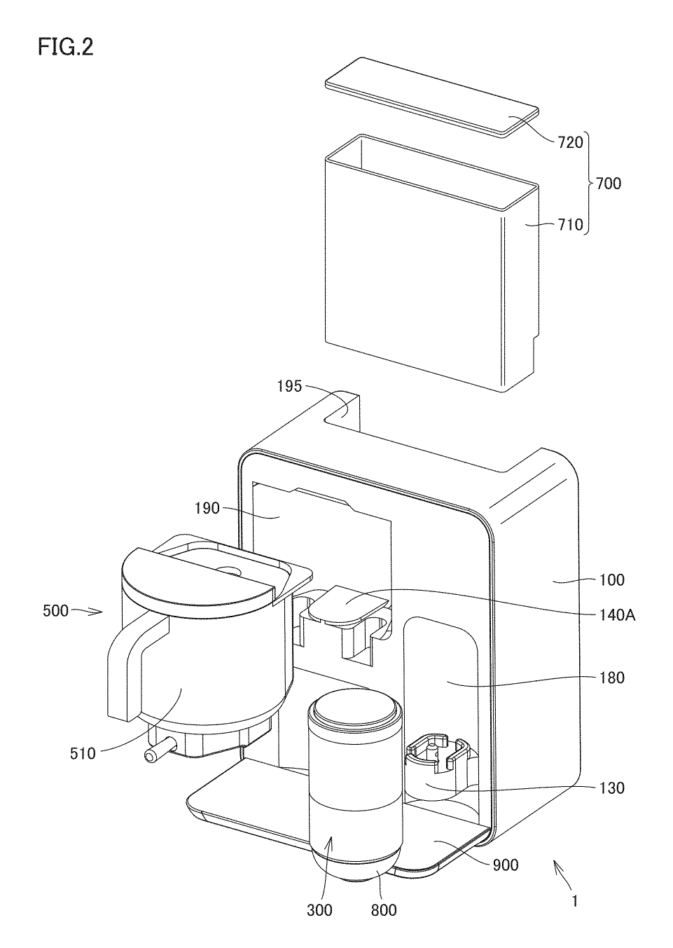

FIG. 1 is an overall perspective view of a beverage preparation apparatus according to the present embodiment. FIG. 2 is an overall perspective view showing a component of the beverage preparation apparatus in FIG. 1. A beverage preparation apparatus 1 according to the present embodiment will be described with reference to FIGS. 1 and 2.

As shown in FIGS. 1 and 2, beverage preparation apparatus 1 according to the present embodiment uses tea leaves as an object to be grated and obtains tea leaf powders by grating the tea leaves. The beverage preparation apparatus uses the obtained tea leaf powders for preparing tea as a beverage. Beverage preparation apparatus 1 includes an apparatus main body 100 as a housing, a milling unit 300, an agitation unit 500, a liquid storage tank 700, a tea leaf powder tray 800, and a placement base 900. Placement base 900 is provided to protrude forward on a front side in a lower portion of apparatus main body 100 and a cup (not shown) and tea leaf powder tray 800 can be placed thereon. Tea leaf powder tray 800 is provided such that a user can hold and move the tray.

(Milling Unit 300)

Milling unit 300 is removably attached to a milling unit attachment portion 180 provided on a front surface side of apparatus main body 100. Milling unit 300 is arranged at a distance from an agitation tank 510 so as not to be superimposed on agitation tank 510 under agitation tank 510 included in agitation unit 500, for example, when viewed from the front.

A milling driving force coupling mechanism 130 is provided in milling unit attachment portion 180 so as to protrude forward and milling unit 300 is removably attached to this milling driving force coupling mechanism 130. Milling unit 300 obtains driving force for milling tea leaves representing an object to be grated by being coupled to milling driving force coupling mechanism 130.

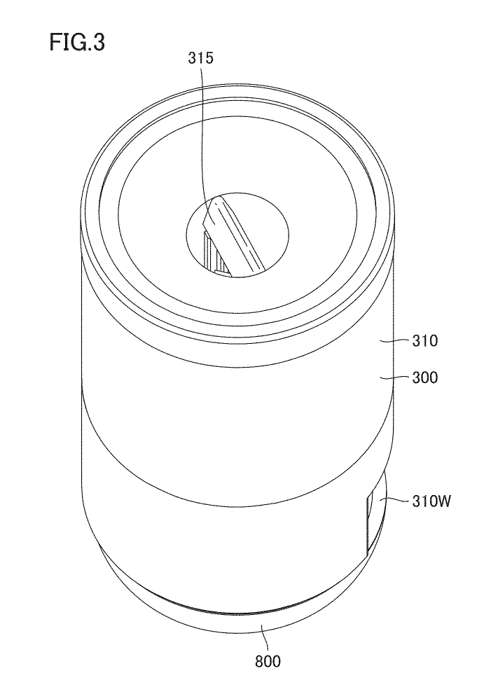

Tea leaves introduced from an upper portion of milling unit 300 into milling unit 300 are finely grated in milling unit 300. The grated tea leaves are dropped and collected as tea leaf powders on tea leaf powder tray 800 placed below milling unit 300. A detailed structure of milling unit 300 will be described later with reference to FIGS. 3 to 5.

(Liquid Storage Tank 700)

Liquid storage tank 700 is removably attached to a liquid storage tank attachment portion 195 provided on an upper surface side of apparatus main body 100. Liquid storage tank 700 includes a tank main body 710 having an opening in an upper surface and a lid portion 720 closing the opening in the upper surface of tank main body 710. Liquid storage tank 700 stores such a liquid as water for supply into agitation tank 510 of agitation unit 500.

(Agitation Unit 500)

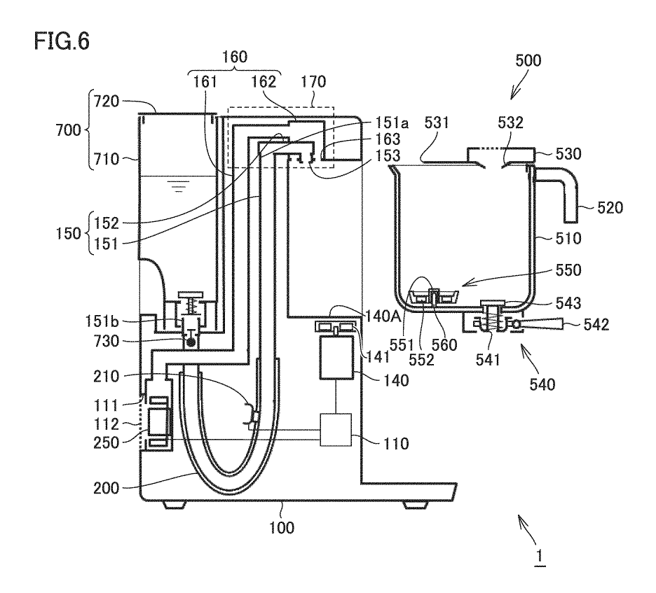

Agitation unit 500 includes agitation tank 510 as a tank to which hot water heated by a heating device 200 (see FIG. 6) which will be described later is supplied and an agitation blade 550 (see FIG. 6) which will be described later. Agitation tank 510 is a container for agitating a liquid and powders. Agitation tank 510 is removably attached to an agitation tank attachment portion 190 provided on the front surface side of apparatus main body 100. Agitation tank 510 is attached to agitation tank attachment portion 190 so as to protrude from apparatus main body 100 in a direction intersecting with a vertical direction. Specifically, agitation tank 510 is attached such that a part of agitation tank 510 protrudes forward from a front surface of apparatus main body 100. A detailed structure of agitation unit 500 will be described later with reference to FIG. 6.

An agitation motor contactless table 140A is provided in agitation tank attachment portion 190. Agitation unit 500 is placed on agitation motor contactless table 140A. Agitation blade 550 provided in agitation unit 500 is rotated by an agitation motor unit 140 (see FIG. 6) and a magnet 141 (see FIG. 6) coupled thereto which are accommodated in apparatus main body 100 so as to be located below agitation motor contactless table 140A.

(Structure of Milling Unit 300)

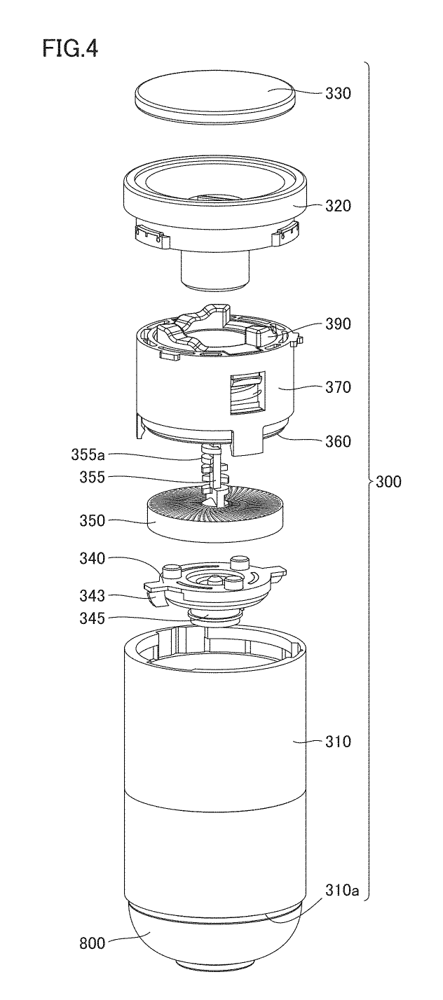

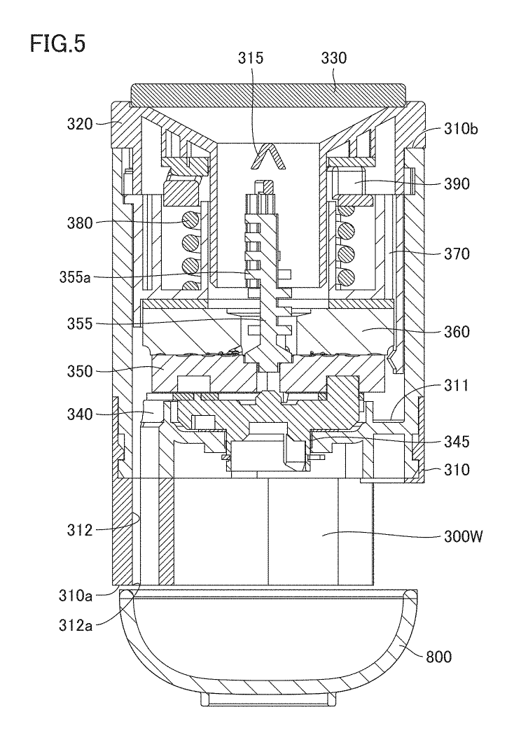

FIG. 3 is a perspective view of the milling unit provided in the beverage preparation apparatus shown in FIG. 1. FIG. 4 is an exploded perspective view of the milling unit shown in FIG. 3. FIG. 5 is a vertical cross-sectional view of the milling unit shown in FIG. 3. A structure of milling unit 300 will be described with reference to FIGS. 3 to 5.

As shown in FIGS. 3 to 5, milling unit 300 has a milling case 310 having a cylindrical shape as a whole and a window 310W for coupling in which milling driving force coupling mechanism 130 is inserted is provided in a side surface below. An outlet port 310a is formed at a lowermost end portion of milling case 310 from which powders of tea leaves grated by milling unit 300 are taken out (drop).

A lower mill support portion 340, a lower mill 350, and an upper mill 360 are sequentially provided from below, in the inside of milling case 310. A milling shaft 345 extending downward is provided on a lower surface of lower mill support portion 340 and coupled to milling driving force coupling mechanism 130 to thereby rotationally drive lower mill 350. A powder scraper portion 343 is provided to protrude horizontally at a peripheral edge of lower mill support portion 340.

A core 355 extending upward along a core of a rotation axis is provided in a central portion of lower mill 350. Upper mill 360 is held by an upper mill holding member 370, and a spring 380 and a spring holding member 390 pressing upper mill 360 downward are accommodated in upper mill holding member 370. Core 355 provided in lower mill 350 extends upward to pass through upper mill 360. A tip end side of core 355 is located in a hopper 320.

A safety rib 315 in a shape projecting upward is formed above core 355. Safety rib 315 of a prescribed size is provided such that tea leaves can be introduced into hopper 320. Though safety rib 315 has a substantially triangular cross-section at an angle acute in an upward direction, limitation to this shape is not intended.

Hopper 320 for supplying an object to be grated in between upper mill 360 and lower mill 350 is attached on a side of an upper end opening portion 310b of milling case 310. Hopper 320 is in a shape of a funnel.

In grating tea leaves, hopper 320 is preferably covered with a cover portion 330. Thus, after tea leaves are introduced into hopper 320, entry of a foreign matter into milling unit 300 can be prevented. Scattering of grated tea leaves to the outside can be prevented. When tea leaves are to be introduced, cover portion 330 is removed from hopper 320.

Tea leaves introduced into hopper 320 are guided in between upper mill 360 and lower mill 350 as a helical blade 355a rotates with rotation of lower mill 350. Tea leaves guided in between upper mill 360 and lower mill 350 are grated and fall downward in a form of tea leaf powders from a circumference of upper mill 360 and lower mill 350.

Some of fallen tea leaf powders is discharged through a discharge path 312 into tea leaf powder tray 800 from a discharge outlet 312a. Other fallen tea leaf powders are stored in a storage portion 311. Tea leaf powders in storage portion 311 are transported to discharge path 312 and discharged from discharge outlet 312a into tea leaf powder tray 800 as powder scraping portion 343 rotates with rotation of lower mill support portion 340.

(Structure of Agitation Unit 500 and Internal Structure of Beverage Preparation Apparatus 1)

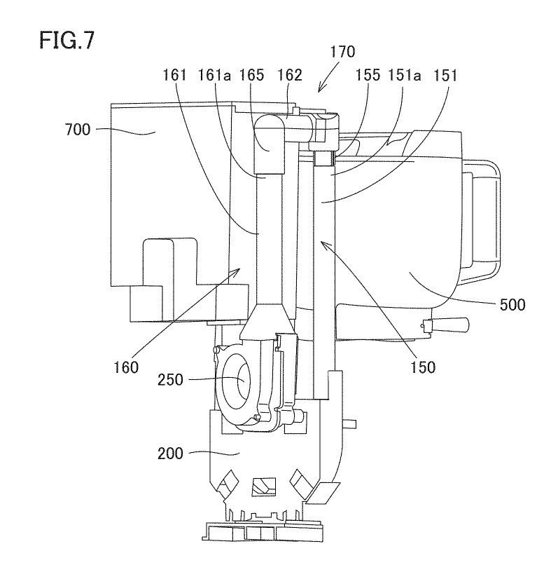

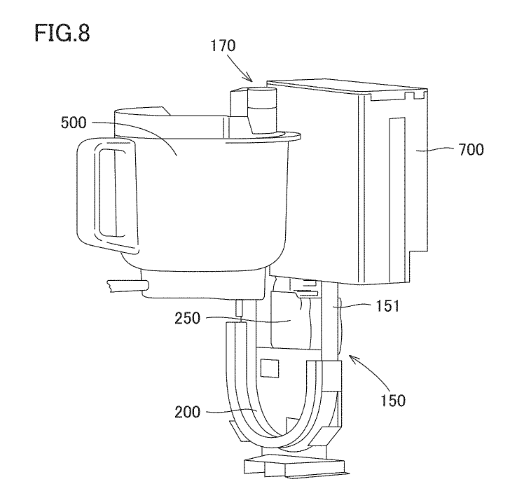

FIG. 6 is a cross-sectional view showing a schematic construction of the beverage preparation apparatus shown in FIG. 1. FIG. 7 is a perspective view of an internal structure of the beverage preparation apparatus shown in FIG. 1 viewed from a side of the tank. FIG. 8 is a perspective view of the internal structure of the beverage preparation apparatus shown in FIG. 1 viewed from a side of the agitation tank. A structure of agitation unit 500 and an internal structure of beverage preparation apparatus 1 will be described with reference to FIGS. 6 to 8.

(Structure of Agitation Unit 500)

As shown in FIG. 6, agitation unit 500 includes agitation tank 510, agitation blade 550, an agitation cover 530, and a discharge port opening and closing mechanism 540. Agitation tank 510 is in a shape of a container having an opening upper surface. Agitation tank 510 accommodates agitation blade 550. Agitation tank 510 includes an exterior holder (not shown) made, for example, of a resin and a thermally insulated tank held by the exterior holder. A grip 520 is provided in agitation tank 510. Grip 520 is formed integrally with the exterior holder with a resin.

Agitation cover 530 is removably attached to an opening portion of agitation tank 510. Agitation cover 530 is provided with a hot water supply inlet 531 through which hot water formed in apparatus main body 100 is poured from a supply nozzle 152 which will be described later and a powder inlet 532 for introducing tea leaf powders grated by milling unit 300. Hot water supply inlet 531 is provided to be able to opposed to a supply port 153 of supply nozzle 152 which will be described later.

Agitation blade 550 is placed on a bottom portion of agitation tank 510. A rotation shaft 560 extending upward is provided on the bottom portion of agitation tank 510, and a cylindrical core 551 of agitation blade 550 is inserted in this rotation shaft 560.

A magnet 552 is embedded in agitation blade 550. In agitation motor contactless table 140A, magnet 552 embedded in agitation blade 550 and magnet 141 provided on a side of agitation motor unit 140 are magnetically coupled in a contactless state, so that rotational driving force of agitation motor unit 140 is transmitted to agitation blade 550.

Agitation blade 550 can be modified as appropriate so long as an agitation member having an agitation element in an outer circumferential portion is provided. A winding portion made of a wire in a toroidal shape or an impeller can be adopted as the agitation element.

Discharge port opening and closing mechanism 540 includes an opening and closing nozzle 543 which closes a discharge port 541 provided at the bottom portion of agitation tank 510 so as to be able to open and close discharge port 541 and an operation lever 542 controlling a position of opening and closing nozzle 543. Opening and closing nozzle 543 is biased to close discharge port 541 by a biasing member (not shown) such as a spring in a normal state. When a user moves operation lever 542 against biasing force, opening and closing nozzle 543 moves to open discharge port 541. Thus, tea in agitation tank 510 is poured into a cup (not shown) placed on placement base 900.

Though an example in which agitation tank 510 is constituted of an exterior holder and a thermally insulated tank in agitation unit 500 described above has been described by way of example, limitation thereto is not intended and the agitation tank may consist of a thermally insulated tank. Instead of a thermally insulated tank, a container which is not thermally insulated but is heat resistant may be employed.

Though an example in which agitation tank 510 is removably attached to apparatus main body 100 in agitation unit 500 described above has been described by way of example, limitation thereto is not intended and the agitation tank may be fixed to apparatus main body 100 so long as powders and hot water can be introduced therein and the inside of agitation tank 510 can be cleaned.

(Internal Structure of Beverage Preparation Apparatus 1)

As shown in FIGS. 6 to 8, beverage preparation apparatus 1 includes a control portion 110, a liquid supply path 150, an air passage path 160, heating device 200, a thermistor 210, and a fan 250. Control portion 110 controls operations of heating device 200, fan 250, milling driving force coupling mechanism 130, and agitation motor unit 140.

Liquid supply path 150 is accommodated in apparatus main body 100. Liquid supply path 150 is connected to liquid storage tank 700. Supply port 153 is provided in liquid supply path 150 on a side opposite to a side where liquid storage tank 700 is connected. Liquid supply path 150 has one end connected to liquid storage tank 700 and the other end serving as the supply port supplying hot water into agitation tank 510.

Liquid supply path 150 includes supply nozzle 152 and a connection pipe 151. Supply nozzle 152 has supply port 153 on a tip end side and has a fitting portion 155 on a side of connection pipe 151. Supply port 153 is provided to be opposed to the bottom portion of agitation tank 510 while agitation tank 510 is attached to agitation tank attachment portion 190.

Fitting portion 155 is provided to removably be fitted to a side of one end 151a of connection pipe 151. Fitting portion 155 is in a cylindrical shape. An inner diameter of fitting portion 155 is slightly greater than an outer diameter of one end 151a of connection pipe 151. By fitting fitting portion 155 to the side of one end 151a of connection pipe 151, connection pipe 151 is connected to supply nozzle 152.

Connection pipe 151 connects supply nozzle 152 and liquid storage tank 700 to each other. Connection pipe 151 extends once downward from a bottom surface of liquid storage tank 700 and extends upward in a U shape. A check valve 730 is provided on a side of the other end 151b of connection pipe 151. Check valve 730 prevents backflow of a liquid in liquid supply path 150 to liquid storage tank 700.

Heating device 200 is provided in a region intermediate in connection pipe 151 of liquid supply path 150. Heating device 200 heats water (liquid) in liquid supply path 150. A liquid in liquid supply path 150 is heated by heating device 200 and the liquid is supplied to agitation tank 510 when a pressure in liquid supply path 150 is equal to or higher than a prescribed pressure. For sterilization of water, water is heated to a temperature not lower than 80° C.

Thermistor 210 is provided in the vicinity of heating device 200. Thermistor 210 inputs information on a temperature of heating device 200 to control portion 110. Control portion 110 determines whether or not a temperature of heating device 200 is equal to or higher than a prescribed temperature based on the information on a temperature from thermistor 210.

When water in liquid supply path 150 is totally supplied to agitation tank 510, heat from heating device 200 is no longer transmitted to water and a temperature of heating device 200 increases. Therefore, by determining whether or not a temperature of heating device 200 is equal to or higher than a prescribed temperature, whether or not water in liquid supply path 150 has been supplied to agitation tank 510 is determined. When it is determined that water in liquid supply path 150 has been supplied to agitation tank 510, control portion 110 stops heating by heating device 200.

Air passage path 160 is a path for sending air into agitation tank 510. Air passage path 160 is accommodated in apparatus main body 100. Air passage path 160 includes an air inlet 111 and an air outlet 163. Air inlet 111 is provided on a side of a rear surface of apparatus main body 100. Air inlet 111 may be provided with an air filter 112 catching dust contained in air.

Air outlet 163 is provided to be opposed to the bottom portion of agitation tank 510 while agitation tank 510 is attached to agitation tank attachment portion 190. Air outlet 163 is provided to surround at least a part of a periphery of supply port 153. In this case, a central axis of air outlet 163 and a central axis of supply port 153 are preferably coaxial.

Air outlet 163 is provided to be able to impinge air at least onto hot water supplied from supply port 153 into agitation tank 510 (hot water which falls into agitation tank 510) in supply of hot water heated by heating device 200 to agitation tank 510.

Air passage path 160 includes an air duct 162 and a connection duct 161. Air duct 162 has air outlet 163 described above on a tip end side and has an insertion portion 165 on a side of connection duct 161. Insertion portion 165 is in a cylindrical shape. An inner diameter of insertion portion 165 is slightly greater than an outer diameter of one end 161a of connection duct 161. By inserting insertion portion 165 into the side of one end 161a of connection duct 161, connection duct 161 is connected to air duct 162. Connection duct 161 connects air duct 162 and air inlet 111 to each other.

Fan 250 is arranged in air passage path 160. Fan 250 sends air taken through air inlet 111 toward air outlet 163. A fan of such a type as a sirocco fan, a propeller fan, or a turbo fan can be adopted as appropriate as fan 250.

Supply nozzle 152 and air duct 162 are formed from path formation member 170.

(Path Formation Member 170)

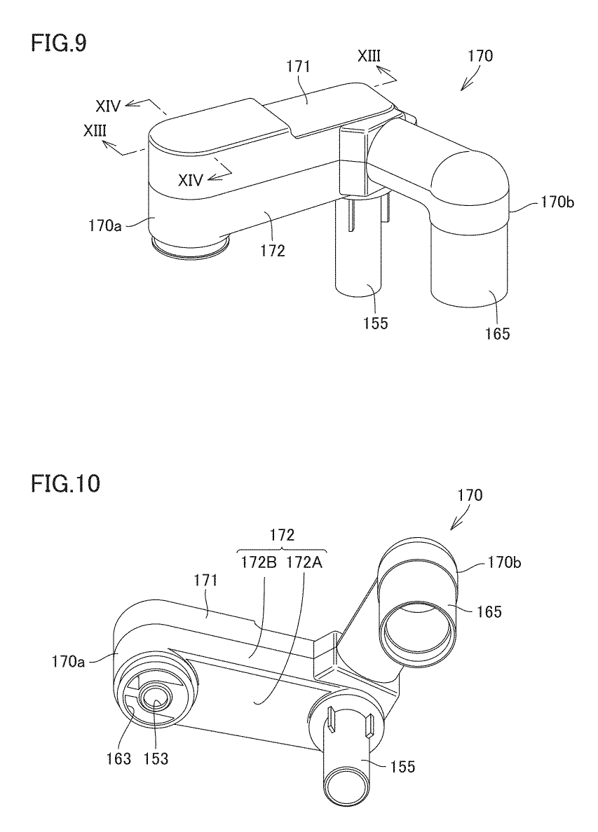

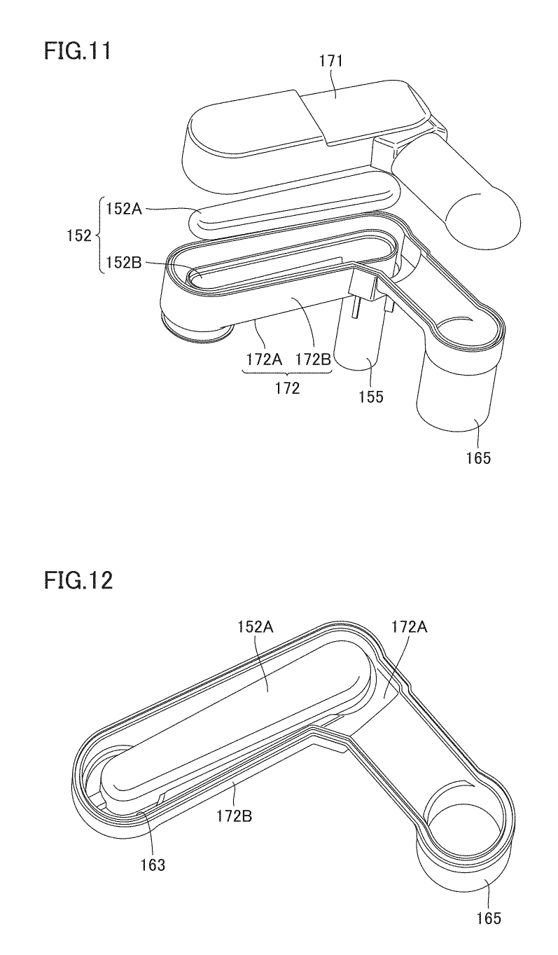

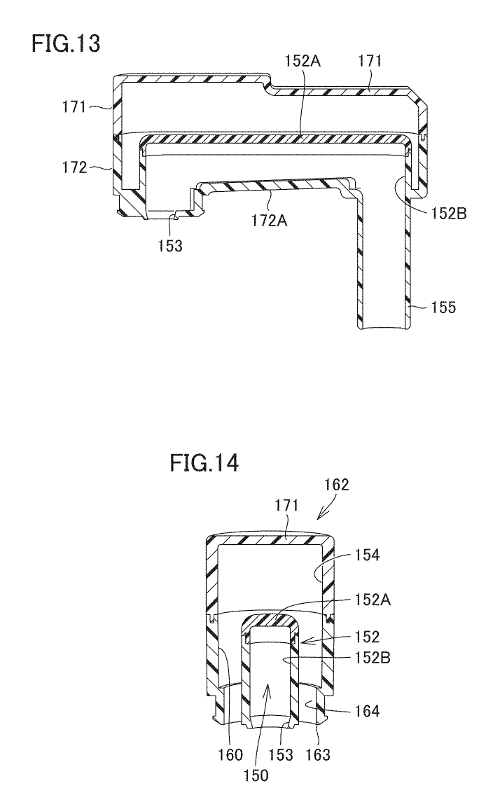

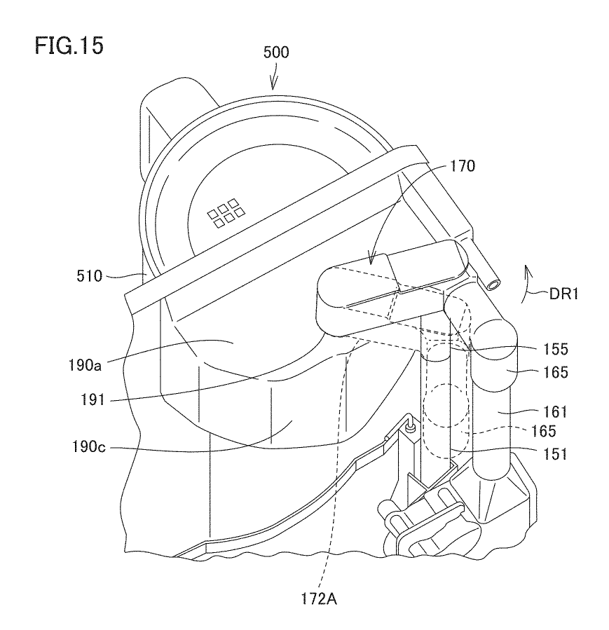

FIG. 9 is a perspective view showing the path formation member shown in FIG. 8. FIG. 10 is a perspective view of the path formation member shown in FIG. 8 viewed from a side of the air outlet and the supply port. FIGS. 11 and 12 are an exploded perspective view and a diagram showing the inside of the path formation member shown in FIG. 8, respectively. FIGS. 13 and 14 are cross-sectional views along the line XIII-XIII and the line XIV-XIV shown in FIG. 9, respectively. Path formation member 170 will be described with reference to FIGS. 9 to 14.

Path formation member 170 has an upper member 171, a lower member 172, and an intermediate member 152A (see FIG. 11). Path formation member 170 is in a substantially L shape. Supply port 153 (see FIG. 10) and air outlet 163 (see FIG. 10) are provided on the side of one end 170a of path formation member 170.

Fitting portion 155 in a cylindrical shape is provided in the vicinity of a bent portion of path formation member 170. Fitting portion 155 is a part of supply nozzle 152 as described above and constitutes a part of liquid supply path 150 for discharging hot water.

Cylindrical insertion portion 165 is provided on the side of the other end 170b of path formation member 170. Insertion portion 165 is a part of air duct 162 as described above and constitutes a part of air passage path 160 for sending air.

The inside of path formation member 170 from the bent portion to one end 170a has a double wall structure. In the inside, a part of air duct 162 (see FIG. 14) is provided to surround supply nozzle 152 (see FIG. 14).

Lower member 172 is provided to open upward. Lower member 172 includes fitting portion 155 and insertion portion 165 described above, a partition portion 152B, a bottom portion 172A, and a peripheral wall portion 172B.

Partition portion 152B is in an oval shape and opens upward. Partition portion 152B is provided to stand from bottom portion 172A in a substantially central portion of lower member 172 extending from the bent portion to one end 170a. Partition portion 152B is provided to connect fitting portion 155 and supply port 153 to each other and to separate supply port 153 and air outlet 163 from each other.

Peripheral wall portion 172B is provided to stand from a peripheral edge of bottom portion 172A. Peripheral wall portion 172B is provided to connect insertion portion 165 and air outlet 163 to each other and to surround partition portion 152B.

Intermediate member 152A is a site closing an opening in an upper surface of partition portion 152B. As intermediate member 152A closes the opening in the upper surface of partition portion 152B, partition portion 152B, intermediate member 152A, and bottom portion 172A define a space communicating with supply port 153 and fitting portion 155. Supply nozzle 152 is thus formed.

Upper member 171 is a site closing an opening in an upper surface of lower member 172. As upper member 171 closes the opening in the upper surface of lower member 172 while supply nozzle 152 is formed, a space separated from the space communicating with supply port 153 and fitting portion 155 described above is provided in path formation member 170. Air duct 162 is thus formed.

The separated space is provided to surround the periphery of supply nozzle 152 except for a side of bottom portion 172A. Therefore, before hot water is supplied from supply port 153 into agitation tank 510, hot water which passes through supply nozzle 152 can be cooled by air sent into air duct 162 with partition portion 152B and intermediate member 152A constituting supply nozzle 152 being interposed.

As upper member 171 closes the opening in the upper surface of lower member 172, an air outlet chamber 154 (see FIG. 14) communicating with air outlet 163 on a side of air outlet 163 and changing a direction of air sent by fan 250 toward agitation tank 510 is provided in air passage path 160.

Air outlet chamber 154 is provided to be able to drain from air outlet 163 toward agitation tank 510, condensation water which adheres to air outlet chamber 154 due to entry from air outlet 163 into air outlet chamber 154 and condensation of vapor from hot water supplied into agitation tank 510.

Specifically, for example, an inner wall portion 164 of air duct 162 in a portion defining air outlet 163 is inclined so as to decrease in inner diameter downward. Bottom portion 172A of lower member 172 in a portion extending from the bent portion toward one end 170a is also preferably provided to be inclined downward from the side of the bent portion toward air outlet 163.

Condensation water which adheres to air outlet chamber 154 runs along the inclined surface of bottom portion 172A and the inclined surface of inner wall portion 164 and is drained through air outlet 163. According to such a construction, condensation water can be prevented from moving toward fan 250. Consequently, a portion driving fan 250 can be prevented from short-circuiting.

(Operation to Attach Path Formation Member 170)

FIG. 15 is a diagram illustrating an operation in attachment of the path formation member shown in FIG. 8. An operation in attachment of path formation member 170 will be described with reference to FIG. 15.

As shown in FIG. 15, in attachment of path formation member 170 to apparatus main body 100, path formation member 170 is attached to an upper wall portion 190a of agitation tank attachment portion 190 such that supply port 153 and air outlet 163 communicate with a through hole 191 provided in upper wall portion 190a of agitation tank attachment portion 190.

A lower end portion on the side of one end 170a of path formation member 170 is provided to protrude downward and the protruding lower end portion is inserted in through hole 191. Thus, tip ends of supply nozzle 152 and air duct 162 are simultaneously inserted in through hole 191 so that supply nozzle 152 and air duct 162 are attached to through hole 191.

While path formation member 170 is attached to upper wall portion 190a, bottom portion 172A faces upper wall portion 190a and fitting portion 155 and insertion portion 165 face a peripheral wall portion 190c. Therefore, by sliding the lower end portion described above with respect to a peripheral surface of upper wall portion 190a defining through hole 191, path formation member 170 can be pivoted in a circumferential direction around a central axis of through hole 191. With pivot of path formation member 170, supply nozzle 152 and air duct 162 are simultaneously pivoted.

In succession, path formation member 170 is pivoted in a direction DR1. After path formation member 170 is pivoted to a prescribed position, fitting portion 155 of path formation member 170 is fitted into connection pipe 151 and insertion portion 165 is inserted in connection duct 161. Thus, supply nozzle 152 and connection pipe 151 are connected to each other so that liquid supply path 150 is provided, and air duct 162 and connection duct 161 are connected to each other so that air passage path 160 is provided.

Thus, by employing path formation member 170 in which air duct 162 and supply nozzle 152 are integrally formed and pivotably attaching path formation member 170 to through hole 191, ease in assembly of beverage preparation apparatus 1 can be improved.

(Supply of Hot Water)

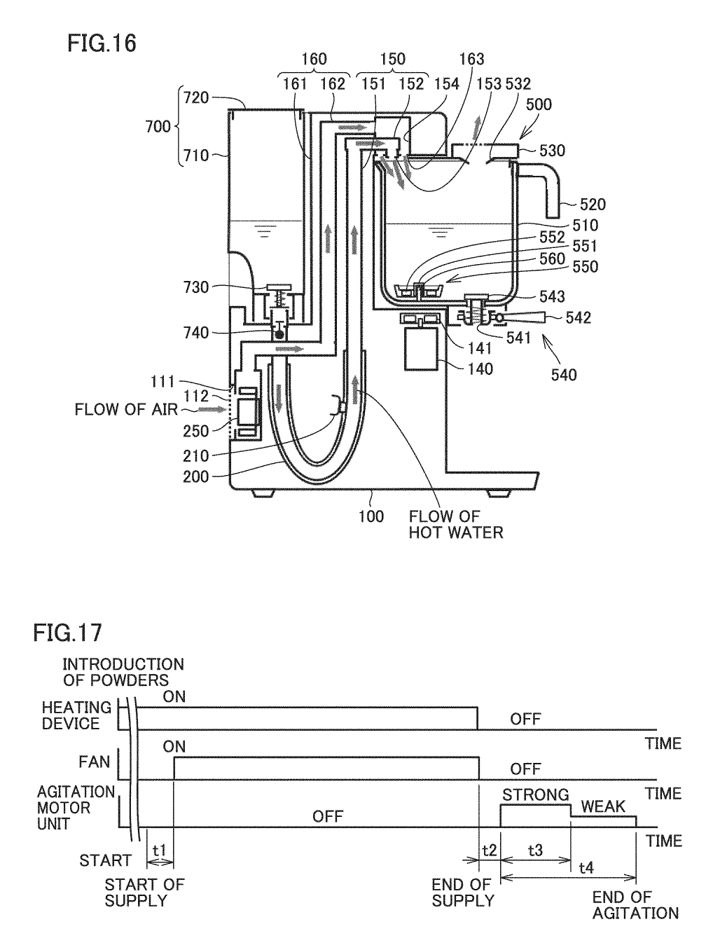

FIG. 16 is a cross-sectional view showing a state of supply of hot water to the agitation tank in the beverage preparation apparatus shown in FIG. 1. A state of supply of hot water to agitation tank 510 in beverage preparation apparatus 1 will be described with reference to FIG. 16.

As shown in FIG. 16, in supply of hot water to agitation tank 510, air provided from air outlet 163 impinges on a liquid being supplied from supply port 153 into agitation tank 510. Air provided from air outlet 163 preferably impinges also on hot water which has been supplied into agitation tank 510.

Thus, hot water supplied into agitation tank 510 can be cooled to a desired temperature. Hot water being supplied to agitation tank 510 can also be cooled so that hot water can efficiently be cooled by removing latent heat of evaporation of hot water by positively bringing hot water into direct contact with air in a portion where hot water is at a relatively high temperature.

FIG. 17 is a diagram showing a timing chart in preparation of tea with the beverage preparation apparatus shown in FIG. 1. Control by control portion 110 in preparation of tea with beverage preparation apparatus 1 will be described with reference to FIG. 17.

As shown in FIG. 17, initially, tea leaf powders are introduced into agitation tank 510. In succession, as a user presses a hot water supply start button provided in apparatus main body 100, a hot water supply start signal is input to control portion 110.

Control portion 110 drives heating device 200 based on the hot water supply start signal. As water in liquid supply path 150 is heated by heating device 200, hot water is supplied to agitation tank 510 when a pressure in liquid supply path 150 is not lower than a prescribed pressure.

Control portion 110 drives fan 250 after lapse of a prescribed time period (t1 seconds) since start of supply of hot water to agitation tank 510. By supplying hot water to agitation tank 510 for t1 seconds, hot water is supplied into agitation tank 510 so as to exceed a height of tea leaf powders. Thus, tea leaf powders can be prevented from being scattered by air provided into agitation tank 510 as fan 250 is driven. The time period of t1 seconds is preferably set to approximately 30 seconds when an amount of water is set to 420 cc and output of heating device 200 is set to 900 W.

Control portion 110 continuously drives heating device 200 and fan 250 until a desired amount of hot water in liquid supply path 150 is supplied into agitation tank 510. Control portion 110 stops drive of heating device 200 and drive of fan 250 at the time point when a desired amount of hot water in liquid supply path 150 is supplied into agitation tank 510.

By driving fan 250, air is impinged on at least hot water being supplied from supply port 153 into agitation tank 510 as described above so as to cool the hot water, and hot water which has been supplied into agitation tank 510 can be cooled. Consequently, a temperature of hot water supplied to agitation tank 510 can be adjusted.

Whether or not a desired amount of hot water has been supplied into agitation tank 510 is determined by control portion 110 based on whether or not a temperature of heating device 200 measured by thermistor 210 as described above has reached a prescribed temperature or higher. For example, whether or not a temperature of heating device 200 is not lower than 103° C. is determined.

Control portion 110 drives agitation motor unit 140 and rotates agitation blade 550 after lapse of a prescribed time period (t2 seconds) since supply of a desired amount of hot water in liquid supply path 150 into agitation tank 510. The time period of t2 seconds is preferably set, for example, to approximately 5 seconds.

With lapse of the prescribed time period (t2 seconds) since supply of the desired amount of hot water in liquid supply path 150 into agitation tank 510, boiled hot water can be stabilized. Thus, scattering of hot water at the time when agitation blade 550 is rotated while hot water is vigorously boiled can be suppressed.

Control portion 110 rotates agitation blade 550 for a prescribed time period (t4 seconds). During initial t3 seconds of t4 seconds, control portion 110 sets high output of agitation motor unit 140 so as to rotate agitation blade 550 fast. For example, agitation blade 550 is preferably rotated approximately at 2000 rpm. The time period of t4 seconds is preferably set to approximately 90 seconds and the time period of t3 seconds is preferably set to approximately 45 seconds.

By rotating agitation blade 550 fast, tea leaf powders accumulated at the bottom portion of agitation tank 510 can efficiently be dissolved and diffused in hot water while air is efficiently taken into the liquid.

After lapse of t3 seconds, control portion 110 sets output of agitation motor unit 140 to be lower so as to rotate agitation blade 550 slowly. For example, agitation blade 550 is preferably rotated approximately at 1000 rpm.

By rotating agitation blade 550 slowly, air taken into the liquid can be crushed by agitation blade 550 and fine foams can be produced. By changing a flow of water by lowering a speed of rotation of agitation blade 550, tea leaf powders can effectively be diffused.

A direction of rotation of agitation blade 550 at the time when agitation blade 550 is rotated slowly may be the same as or opposite to a direction of rotation at the time when agitation blade 550 is rotated fast. When the directions of rotation are set to be opposite to each other, flows of water different in direction of travel collide with each other so that tea leaf powders can more effectively be diffused.

Control portion 110 stops drive of agitation motor unit 140 and quits agitation of tea leaf powders and hot water by agitation blade 550 after it drives agitation motor unit 140 for a prescribed time period (t4 seconds).

As set forth above, beverage preparation apparatus 1 according to the present embodiment is provided with fan 250 and provided with air outlet 163 such that air can impinge at least on hot water being supplied from supply port 153 into agitation tank 510 in supply of hot water heated by heating device 200 to agitation tank 510. Thus, hot water supplied into agitation tank 510 can be adjusted to a desired temperature.

By using the fan, as compared with such a construction that a heat exchanger or a pump is used to control a temperature of hot water in advance and hot water at a desired temperature is supplied into the agitation tank, a temperature of the liquid can be adjusted with a more simplified construction. By impinging air also onto hot water being supplied, hot water can efficiently be cooled.

Additionally, by diffusing tea leaf powders in hot water adjusted to a desired temperature, tea as preferred by a user can be prepared.

In general, when a temperature of hot water is high (for example, approximately 90° C.), a large amount of an acerbic component such as tannin is eluted from tea leaf powders into hot water and acerbic and bitter tea is prepared.

In the present embodiment, elusion of an acerbic component such as tannin can be suppressed and a ratio of a sweet component such as theanine can be increased by adjusting a temperature of hot water to a desired temperature. Thus, savory and sweet tea can be prepared. By setting a temperature of hot water to 70° C. or lower, a tea of which savory and sweet flavor is pronounced can be prepared and tea at a temperature easy to drink can be prepared.

In the present embodiment, a temperature of hot water supplied into agitation tank 510 can be adjusted as appropriate by adjusting a time period for driving fan 250 and/or the number of rotations of fan 250 as appropriate.

Though an example in which supply nozzle 152 and air duct 162 constitute a double wall structure has been described in the first embodiment described above by way of example, limitation thereto is not intended and supply nozzle 152 and air duct 162 may be provided independently of each other so long as air can impinge on hot water supplied from supply nozzle 152 to agitation tank 510.

In this case, a through hole for attachment of supply nozzle 152 and a through hole for attachment of air duct 162 may be provided in upper wall portion 190a of agitation tank attachment portion 190 of apparatus main body 100, and supply nozzle 152 and air duct 162 are pivotably attached to the through holes such that supply port 153 and air outlet 163 face the respective through holes.

A single through hole may be provided and supply nozzle 152 and air duct 162 are pivotably attached to the through hole such that supply port 153 and air outlet 163 face the single through hole.

Supply nozzle 152 and air duct 162 are thus pivotably attached to upper wall portion 190a of agitation tank attachment portion 190 so that ease in assembly of liquid supply path 150 and air passage path 160 can be improved.

Though an example in which air impinges at least on hot water being supplied from supply port 153 into agitation tank 510 (hot water which falls into the agitation tank) has been described in the first embodiment described above by way of example, limitation thereto is not intended, and air outlet 163 should only be provided to be able to send air to hot water such that air is in contact with hot water being supplied from supply port 153 into agitation tank 510. For example, air outlet 163 may be provided to send air along hot water being supplied from supply port 153 into agitation tank 510. In such a case as well, a temperature of hot water can be adjusted to a desired temperature by removing latent heat of evaporation of hot water by bringing air into direct contact with hot water.

### Second Embodiment

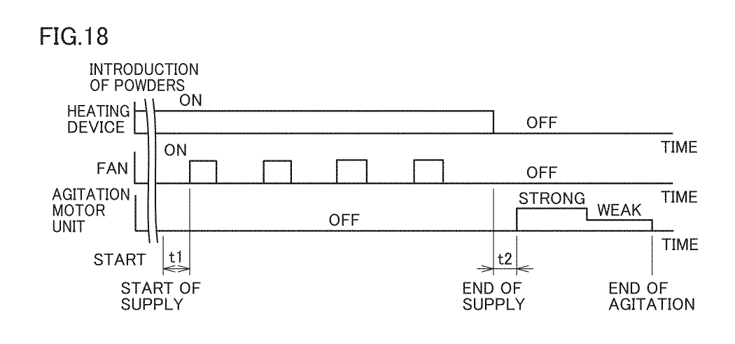

FIG. 18 is a timing chart in preparation of tea with a beverage preparation apparatus according to the present embodiment. Control by the control portion in preparation of tea with the beverage preparation apparatus according to the present embodiment will be described with reference to FIG. 18. The beverage preparation apparatus according to the present embodiment is substantially the same in construction as beverage preparation apparatus 1 according to the first embodiment.

As shown in FIG. 18, control by the control portion in preparation of tea with the beverage preparation apparatus according to the present embodiment is different in method of driving fan 250 from control by the control portion in preparation of tea with the beverage preparation apparatus according to the first embodiment.

In control according to the present embodiment, control portion 110 intermittently drives fan 250 after lapse of t1 seconds since start of supply of hot water to agitation tank 510 until stop of supply of hot water to agitation tank 510. Time to drive fan 250 and time to stop driving can be set as appropriate.

When a time period after lapse of a prescribed time period (t1 seconds) since start of supply of hot water to agitation tank 510 until end of supply of hot water to agitation tank 510 is set to be the same as in the first embodiment, a time period for driving fan 250 decreases, and therefore a temperature of hot water supplied to agitation tank 510 can be higher in the present embodiment than in the first embodiment.

Thus, the beverage preparation apparatus according to the present embodiment can also adjust a temperature of hot water supplied to agitation tank 510 and can obtain an effect substantially the same as that of the beverage preparation apparatus according to the first embodiment.

### Third Embodiment

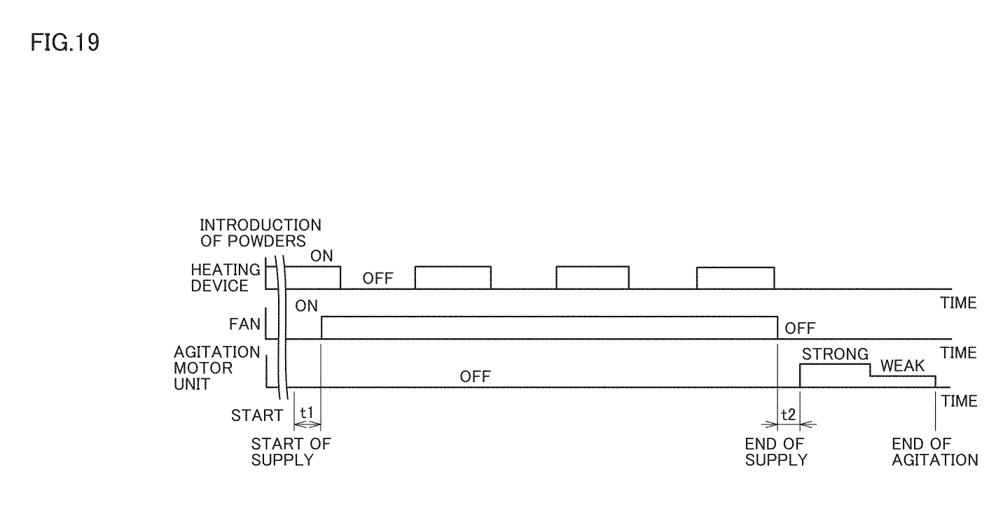

FIG. 19 is a timing chart in preparation of tea with a beverage preparation apparatus according to the present embodiment. Control by the control portion in preparation of tea with the beverage preparation apparatus according to the present embodiment will be described with reference to FIG. 19. The beverage preparation apparatus according to the present embodiment is substantially the same in construction as beverage preparation apparatus 1 according to the first embodiment.

As shown in FIG. 19, control by the control portion in preparation of tea with the beverage preparation apparatus according to the present embodiment is different in method of driving heating device 200 from control by the control portion in preparation of tea with the beverage preparation apparatus according to the first embodiment.

In control according to the present embodiment, control portion 110 intermittently drives heating device 200. Time to drive heating device 200 and time to stop driving can be set as appropriate.

In this case, by intermittently driving heating device 200, a time period until end of supply of hot water to agitation tank 510 is longer than in the first embodiment, however, hot water is also supplied intermittently to agitation tank 510 and therefore a cooling effect can be enhanced. Therefore, a temperature of hot water supplied to agitation tank 510 can be lower in the present embodiment than in the first embodiment.

Thus, the beverage preparation apparatus according to the present embodiment can also adjust a temperature of hot water supplied to agitation tank 510 and can obtain an effect substantially the same as that of the beverage preparation apparatus according to the first embodiment.

### Fourth Embodiment

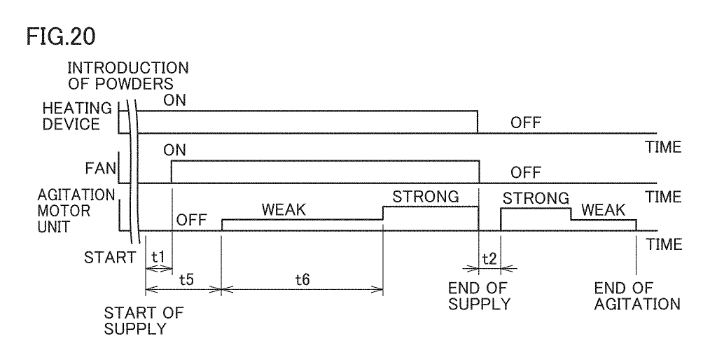

FIG. 20 is a timing chart in preparation of tea with a beverage preparation apparatus according to the present embodiment. Control by the control portion in preparation of tea with the beverage preparation apparatus according to the present embodiment will be described with reference to FIG. 20. The beverage preparation apparatus according to the present embodiment is substantially the same in construction as beverage preparation apparatus 1 according to the first embodiment.

As shown in FIG. 20, control by the control portion in preparation of tea with the beverage preparation apparatus according to the present embodiment is different in method of driving agitation motor unit 140 from control by the control portion in preparation of tea with the beverage preparation apparatus according to the first embodiment.

In control according to the present embodiment, control portion 110 drives agitation motor unit 140 after lapse of a prescribed time period (t5 seconds) since start of supply of hot water to agitation tank 510 until end of supply of hot water to agitation tank 510.

Specifically, control portion 110 rotates agitation blade 550 at a low speed with output of agitation motor unit 140 being set to be low after lapse of the prescribed time period (t5 seconds) since start of supply of hot water to agitation tank 510 until lapse of a prescribed time period (t6 seconds). During a time period until end of supply of hot water to agitation tank 510 after rotation of agitation blade 550 at a low speed, control portion 110 sets output of agitation motor unit 140 to be higher so as to rotate agitation blade 550 at a high speed. In this case, the time period of t5 seconds is preferably set to 60 seconds and the time period of t6 seconds is preferably set to 60 seconds.

Control portion 110 allows the prescribed time period (t5 seconds) to elapse since start of supply of hot water to agitation tank 510, so that hot water in an amount allowing suppression of scattering of hot water and noise in spite of rotation of agitation blade 550 at a low speed can be supplied into agitation tank 510.

By allowing lapse of the prescribed time period (t6 seconds) after rotation of agitation blade 550 at a low speed, hot water in an amount allowing suppression of scattering of hot water and noise in spite of rotation of agitation blade 550 at a high speed can be supplied to agitation tank 510.

By impinging air onto hot water supplied to agitation tank 510 while hot water supplied to agitation tank 510 is agitated, hot water in agitation tank 510 can be cooled as a whole as compared with an example in which agitation is not performed. Therefore, a temperature of hot water supplied to agitation tank 510 can be lower in the present embodiment than in the first embodiment.

Thus, the beverage preparation apparatus according to the present embodiment can also adjust a temperature of hot water supplied to agitation tank 510 and can obtain an effect substantially the same as that of the beverage preparation apparatus according to the first embodiment.

(Verification Experiment)

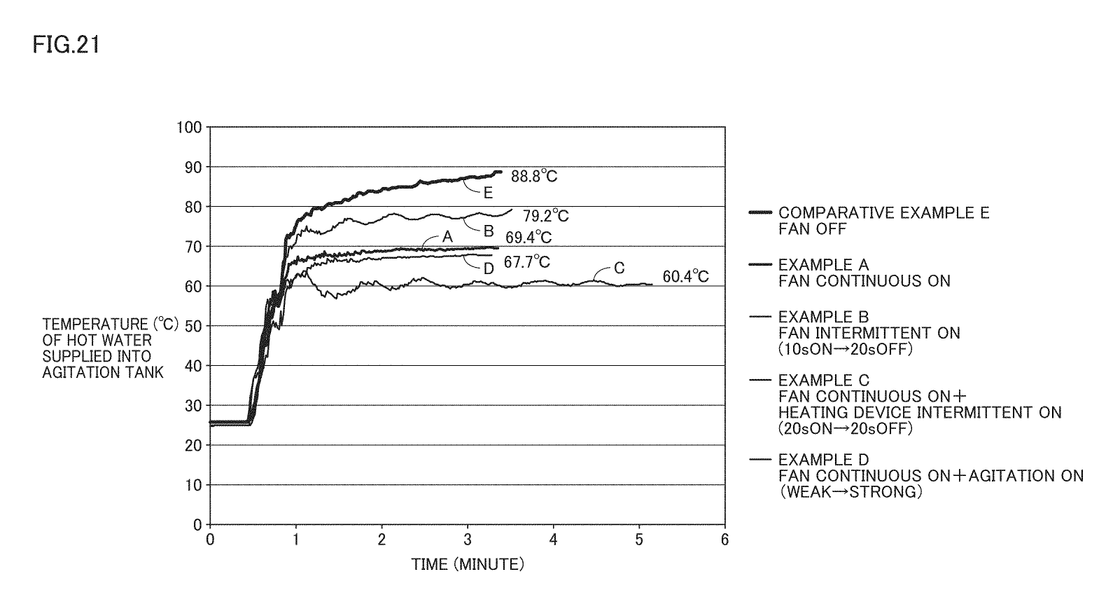

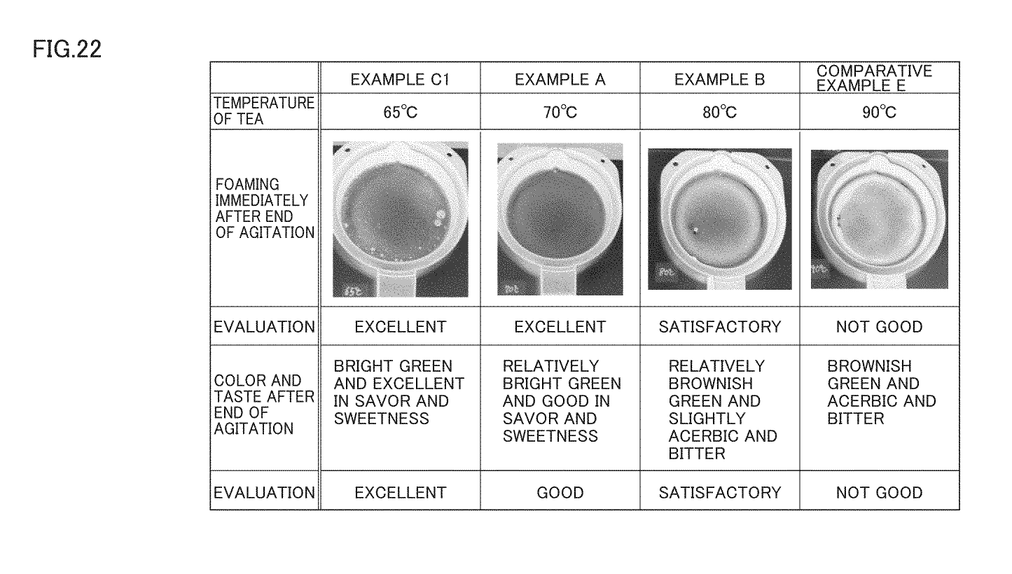

FIG. 21 is a diagram showing a condition and a result of a first verification experiment conducted for verifying an effect of the present invention. FIG. 22 is a diagram showing a condition and a result of a second verification experiment conducted for verifying an effect of the present invention. The first verification experiment and the second verification experiment conducted for verifying the effects of the present invention will be described with reference to FIGS. 21 and 22.

In the first verification experiment, a temperature of hot water around a bottom in the inside of agitation tank 510 from start of supply of hot water to agitation tank 510 until end of agitation was measured in Examples A to D and Comparative Example E. Hot water was prepared by boiling 420 cc of water and a heater of which output was 900 W was employed as heating device 200.

In measurement of a temperature, a temperature sensor such as a thermocouple was set around the bottom in the inside of agitation tank 510 and a temperature of hot water in agitation tank 510 was directly measured. The temperature sensor was set to constantly be in direct contact with hot water also during agitation of hot water.

In Examples A, B, and D and Comparative Example E, supply of hot water into agitation tank 510 ended substantially in three minutes, and in Example C, supply of hot water into agitation tank 510 ended substantially in five minutes. Measurement was conducted until a time point when a temperature of hot water was the highest. Thereafter, in any of Examples and Comparative Example, agitation was started after lapse of several seconds since end of supply of hot water, however, measurement of a temperature of hot water was not conducted because the temperature gradually lowered due to agitation.

In Example A, tea was prepared with the beverage preparation apparatus in the first embodiment. In Example B, tea was prepared with the beverage preparation apparatus in the second embodiment. For control for intermittent drive of fan 250, fan 250 was driven for 10 seconds and thereafter stopped for 20 seconds.

In Example C, tea was prepared with the beverage preparation apparatus in the third embodiment. For control for intermittent drive of heating device 200, a cycle of driving heating device 200 for 20 seconds and thereafter resting the heating device for 20 seconds was repeated two to three times.

In Example D, tea was prepared with the beverage preparation apparatus in the fourth embodiment. In Comparative Example E, tea was prepared with the beverage preparation apparatus in the first embodiment while fan 250 was not driven.

In Example A, a temperature of hot water supplied to agitation tank 510 could be adjusted to approximately 70° C.

In Example B, a temperature of hot water supplied to agitation tank 510 could be adjusted to approximately 80° C.

In Example C, a temperature of hot water supplied to agitation tank 510 could be adjusted to approximately 60° C.

In Example D, a temperature of hot water could be adjusted to a temperature lower than in Example A by agitating hot water supplied into agitation tank 510 while hot water was supplied to agitation tank 510.

In Comparative Example E, a temperature of hot water supplied to agitation tank 510 was approximately 90° C., and a state of high temperature was maintained.

It was confirmed from the results above also experimentally that hot water supplied to agitation tank 510 could be adjusted to a desired temperature with a simplified construction by providing fan 250 and providing air outlet 163 to be able to send air at least toward hot water being supplied from supply port 153 into agitation tank 510 in supply of hot water heated by heating device 200 to agitation tank 510.

It was confirmed also experimentally that a range of temperature adjustment could be broadened by intermittently driving fan 250, intermittently driving heating device 200, or agitating hot water by the time of end of supply of hot water into agitation tank 510.

In the second verification experiment, a state of foaming, a color, and a flavor of tea were evaluated in Examples A, B, and C1 and Comparative Example E. In connection with a state of foaming, tea excellent in foaming was determined as “excellent”, tea relatively good in foaming was determined as “good”, and tea poor in foaming was determined as “not good.”

In connection with a color and a flavor, tea which was bright green and excellent in savor and sweetness was determined as “excellent”, tea which was relatively bright green and good in savor and sweetness was determined as “good”, tea which was relatively brownish and was slightly acerbic and bitter was determined as “satisfactory”, and tea which was brownish and acerbic and bitter was determined as “not good.”

In Examples A and B and Comparative Example E, tea was prepared as in the first verification experiment described above, and tea at a temperature of approximately 70° C., 80° C., and 90° was prepared. In Example C1, tea at a temperature of approximately 65° C. was prepared by adjusting a time period for driving heating device 200 as compared with the first verification experiment.

In Example A, a large amount of fine foams was produced and tea smooth in texture and excellent in gulp feeling was prepared. In Example A, tea which was bright green and good in savor and sweetness was prepared. Thus, Example A was determined as “excellent” in a state of foaming and determined as “good” in color and flavor.

In Example B, fine foams relatively smaller in amount than in Example A were produced, and tea relatively good in smooth texture and relatively good in gulp feeling was prepared. In Example B, tea which was relatively brownish and slightly acerbic and bitter was prepared. Thus, Example B was determined as “satisfactory” in a state of foaming and determined as “satisfactory” in color and flavor.

In Example C1, a large amount of fine foams was produced and tea excellent in smooth texture and excellent in gulp feeling was prepared. In Example C1, tea which was bright green and good in savor and sweetness was prepared. Thus, Example C1 was determined as “excellent” in state of foaming and determined as “excellent” in color and flavor.

In Comparative Example E, tea small in amount of fine foams and less likely to be foamed was prepared. In Comparative Example E, tea which was brownish and acerbic and bitter was prepared. Thus, Comparative Example E was determined as “not good” in state of foaming and determined as “not good” in color and flavor.

It was confirmed from the results above also experimentally that tea different in state of foaming, color, and flavor could be prepared as preferred by a user by providing fan 250 and adjusting a temperature of hot water supplied to agitation tank 510 with a simplified construction.

It was confirmed also experimentally that tea which was excellent in foaming, bright green, and good in savor and sweetness could be prepared by adjusting a temperature of hot water supplied to agitation tank 510 to 70° C. or lower. An effect of sterilization of water is also achieved by heating water to 80° C. or higher and then adjusting a temperature to 70° C. or lower.

Though the embodiments of the present invention have been described above, the embodiments disclosed herein are illustrative and non-restrictive in every respect. The scope of the present invention is defined by the terms of the claims and is intended to include any modifications within the scope and meaning equivalent to the terms of the claims.

### REFERENCE SIGNS LIST

1 beverage preparation apparatus; 100 apparatus main body; 110 control portion; 111 air inlet; 112 air filter; 130 milling driving force coupling mechanism; 140 agitation motor unit; 140A contactless table; 141 magnet; 150 liquid supply path; 151 connection pipe; 152 supply nozzle; 152A intermediate member; 152B partition portion; 153 supply port; 154 air outlet chamber; 155 fitting portion; 160 air passage path; 161 connection duct; 162 air duct; 163 air outlet; 164 inner wall portion; 165 insertion portion; 170 path formation member; 171 upper member; 172 lower member; 172A bottom portion; 172B peripheral wall portion; 180 milling unit attachment portion; 190 agitation tank attachment portion; 190a upper wall portion; 190c peripheral wall portion; 191 through hole; 195 liquid storage tank attachment portion; 200 heating device; 210 thermistor; 250 fan; 300 milling unit; 310 case; 310W window for coupling; 310a outlet port; 310b upper end opening portion; 311 storage portion; 312 discharge path; 312a discharge outlet; 315 safety rib; 320 hopper; 330 cover portion; 340 mill support portion; 343 powder scraping portion; 345 milling shaft; 350 lower mill; 355 core; 355a helical blade; 360 upper mill; 370 upper mill holding portion; 380 spring; 390 spring holding member; 500 agitation unit; 510 agitation tank; 520 grip; 530 agitation cover; 531 hot water supply inlet; 532 powder inlet; 540 discharge port opening and closing mechanism; 541 discharge port; 542 operation lever; 543 opening and closing nozzle; 550 agitation blade; 551 cylindrical core; 552 magnet; 560 rotation shaft; 700 liquid storage tank; 710 tank main body; 720 lid portion; 730 check valve; 800 tea leaf powder tray; and 900 placement base.

1. A beverage preparation apparatus comprising:
a liquid storage tank storing a liquid;
a heating device for heating the liquid;
a tank to which the liquid heated by the heating device is supplied;
a liquid supply path having one end connected to the liquid storage tank and the other end serving as a supply port supplying the liquid to the tank;
an air passage path including an air inlet and an air outlet for sending air into the tank; and
a fan arranged in the air passage path,
the air outlet being provided to send air at least to the liquid supplied from the supply port into the tank in supply of the liquid heated by the heating device to the tank.

2. The beverage preparation apparatus according to claim 1, wherein
the air outlet is provided in at least a part of a periphery of the supply port.

3. The beverage preparation apparatus according to claim 1, wherein
the air passage path includes an air outlet chamber communicating with the air outlet on a side of the air outlet and changing a direction of air sent by the fan toward the tank, and
the air outlet chamber is provided to be able to drain from the air outlet toward the tank, condensation water which adheres to the air outlet chamber due to entry from the air outlet into the air outlet chamber and condensation of vapor from the liquid supplied into the tank.

4. The beverage preparation apparatus according to claim 1, the beverage preparation apparatus further comprising a housing accommodating the liquid supply path and the air passage path, wherein
the housing has a through hole such that the supply port and the air outlet face the tank,
the liquid supply path includes a supply nozzle provided with the supply port and a connection pipe connecting the supply nozzle and the liquid storage tank to each other,
the supply nozzle has a fitting portion removably fitted to the connection pipe and is pivotably attached to the through hole such that the supply port communicates with the through hole,
the liquid supply path is provided by pivoting the supply nozzle and fitting the fitting portion into the connection pipe after the supply nozzle is attached to the through hole,
the air passage path includes an air duct provided with the air outlet and a connection duct connecting the air duct and the air inlet to each other,
the air duct has an insertion portion removably inserted in the connection duct and is pivotably attached to the through hole such that the air outlet communicates with the through hole, and
the air passage path is provided by pivoting the air duct and inserting the insertion portion into the connection duct after the air duct is attached to the through hole.

5. The beverage preparation apparatus according to claim 4, wherein
the supply nozzle and the air duct constitute a double wall structure, and
the supply nozzle and the air duct are simultaneously attached to the through hole.
